(19) United States
(12) Patent Application Publication
(10) Pub. No.: US 2010/0081063 A1
(43) Pub. Date: Apr. 1, 2010

(54) NON-AQUEOUS ELECTROLYTE SECONDARY BATTERY

(75) Inventors: Hidekazu Yamamoto, Kobe-city (JP); Atsushi Fukui, Kobe-city (JP); Taizou Sunano, Kobe-city (JP); Maruo Kamino, Kobe-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/568,332

(22) Filed: Sep. 28, 2009

(30) Foreign Application Priority Data
Sep. 30, 2008 (JP) 2008-252261
Aug. 6, 2009 (JP) 2009-182966

(51) Int. Cl. H01M 6/16

(52) U.S. Cl. 429/338

(57) ABSTRACT

A non-aqueous electrolyte secondary battery has a positive electrode, a negative electrode, a separator interposed between the positive electrode and the negative electrode, and a non-aqueous electrolyte dissolving a solute in a non-aqueous solvent wherein the negative electrode contains a negative electrode active material containing powdered silicon and/or silicon alloy and a binding agent, and the non-aqueous electrolyte contains a fluorinated cyclic carbonate represented by a general formula (1) below, and wherein when Li storage volume per unit area in the negative electrode during charging is determined as A and the theoretical maximum Li storage volume per unit area in the negative electrode is determined as B, a utilizing rate (%) of negative electrode as expressed by (A/B)×100 is 45% or less.

### RELATED APPLICATIONS

The priority application number(s) JP-A 2008-252261 and JP-A 2009-182966 upon which this application is based is hereby incorporated by reference.

### BACKGROUND OF THE INVENTION

1. Field of the Invention

The present invention relates to a non-aqueous electrolyte secondary battery comprising a positive electrode, a negative electrode, a separator interposed between the positive electrode and the negative electrode and a non-aqueous electrolyte dissolving a solute in a non-aqueous solvent. More particularly, the invention relates to a non-aqueous electrolyte secondary battery wherein powdered silicon and/or silicon alloy is used for a negative electrode active material of a negative electrode for the purpose of higher battery capacity and a great decrease of capacity resulting from charging and discharging under high temperature is prevented so that excellent charge-discharge cycle performances under high temperature can be obtained.

2. Description of the Related Art

In recent years, as a power supply for a mobile electric device or electric power storage, a non-aqueous electrolyte secondary battery is in use, which employs a non-aqueous electrolyte and which is adapted for charging and discharging by way of transfer of lithium ions between a positive electrode and a negative electrode.

In such a non-aqueous electrolyte secondary battery, graphite material is in wide use as a negative electrode active material in a negative electrode.

The use of graphite material has the following benefits. Since graphite material has a flat discharging electric potential and charging and discharging is performed by insertion and de-insertion of lithium ions among its graphite crystals, generation of acicular metal lithium is prevented and volume change due to charging and discharging is small.

On the other hand, in recent years, miniaturization and weight saving of mobile computing devices, such as a cellular phone, notebook PC, and PDA have been remarkably advanced. Further, power consumption has also been increasing with multi-functionalization. As a result, demands for miniaturization and weight saving in a non-aqueous electrolyte secondary battery used as these power supplies have been increasing.

However, there is a problem that such graphite material does not necessarily have a sufficient capacity and therefore is hard to sufficiently meet such demands.

Therefore, recently, the use of materials to be alloyed with lithium, such as silicon, germanium, and tin, has been examined as the negative electrode active material with high capacity. Particularly, the use of silicon and silicon alloy as the negative electrode active material has been examined because silicon has a large theoretical capacity of about 4000 mAh/g.

However, in the case of using materials such as silicon to be alloyed with lithium, volume change associated with the insertion and de-insertion of lithium is great and deterioration resulting from expansion by charging and discharging is caused. Further, materials such as silicon easily react with a commonly-used non-aqueous electrolyte. Therefore, a negative electrode material such as silicon is deteriorated by reaction between a non-aqueous electrolyte and itself, and there still remains a problem that charge-discharge cycle performances are lowered.

In this connection, as disclosed in patent document 1, there has been proposed a non-aqueous electrolyte secondary battery which comprises a negative electrode wherein a thin film of negative electrode active material containing materials to be alloyed with lithium is formed on the current collector and this thin film of the negative electrode active material is separated by gaps formed in the thickness direction into pillar shapes. Also, the patent document 1 has proposed to add carbonate compounds, for example, ethylene carbonate bonded with fluorine such as 4-fluoro-1,3-dioxolane-2-on, to a non-aqueous electrolytic solution used in the non-aqueous electrolyte secondary battery. Further, the patent document 1 discloses that deterioration of the negative electrode active material caused by expansion because of charging and discharging and by reaction between a non-aqueous electrolyte and itself is suppressed in such a non-aqueous electrolyte secondary battery.

In the patent document 2, there has been proposed a battery comprising a negative electrode active material containing Si and Sn and an electrolyte containing a solvent of halogenated carbonic ester. This document shows the following effect. The electrolyte containing the solvent of halogenated carbonic ester contributes to form a good coating. Thereby, decomposition of the electrolyte is restricted, and discharge capacity under low temperature as well as charging and discharging efficiency are improved.

Patent document 1: JP-A 2006-86058

Patent document 2: JP-A 2006-294403

### SUMMARY OF THE INVENTION

The inventors of the present invention had examined charge-discharge cycle performances of a non-aqueous electrolyte secondary battery wherein silicon or silicon alloy is used as a negative electrode active material and a non-aqueous electrolyte contains carbonate chemical bonded with fluorine and ethylene carbonate chemical bonded with fluorine.

The results of examinations of the non-aqueous electrolyte secondary battery as described above employing a negative electrode wherein silicon or silicon alloy was formed on a negative electrode current collector by CVD method, sputtering method, vacuum deposition method, flame spraying method, and metal plating method showed that such a non-aqueous electrolyte secondary battery had excellent charge-discharge cycle performances even if being subjected to charging and discharging under high temperature. On the other hand, as compared with the negative electrode as described above, a non-aqueous electrolyte secondary battery employing a negative electrode comprising a negative electrode active material containing powdered silicon and/or silicon alloy and a binding agent is characterized by easier production and lower production cost. However, in such a non-aqueous electrolyte secondary battery, carbonate chemical bonded with fluorine and ethylene carbonate chemical bonded with fluorine react with the negative electrode in the case of charging and discharging under high temperature. As a result, charge-discharge cycle performances in such a non-aqueous electrolyte secondary battery are deteriorated as compared with a non-aqueous electrolyte secondary battery comprising a non-aqueous electrolyte which does not contain carbonate chemical bonded with fluorine or ethylene carbonate chemical bonded with fluorine.

It is an object of the invention to restrict great deterioration of charge-discharge cycle performances of a non-aqueous electrolyte secondary battery employing a negative electrode comprising a negative electrode active material containing powdered silicon and/or silicon alloy and a binding agent even if charging and discharging is conducted under high temperature so that excellent charge-discharge cycle performances can be obtained.

According to the present invention, a non-aqueous electrolyte secondary battery comprises:

a positive electrode; a negative electrode; a separator interposed between the positive electrode and the negative electrode; and a non-aqueous electrolyte dissolving a solute in a non-aqueous solvent; wherein the negative electrode comprises a negative electrode active material containing powdered silicon and/or silicon alloy and a binding agent, and the non-aqueous electrolyte contains a fluorinated cyclic carbonate having fluorine group and alkyl group and being represented by the general formula (1) below. When Li storage volume per unit area in the negative electrode during charging is determined as A and the theoretical maximum Li storage volume per unit area in the negative electrode is determined as B, a utilizing rate (%) of negative electrode as expressed by (A/B)×100 is 45% or less.

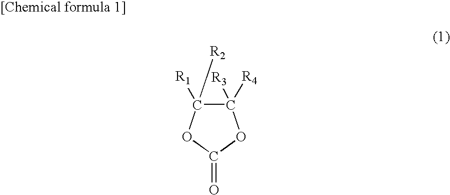

(In the chemical formula, R1 to R4 are groups selected from hydrogen group, fluorine group and alkyl group and contain at least one fluorine group and one alkyl group respectively.)

As the same as non-aqueous electrolyte secondary battery of the present invention, when a negative electrode comprising a negative electrode active material containing powdered silicon and/or silicon alloy and a binding agent is used, and a fluorinated cyclic carbonate which has fluorine group and alkyl group and is represented by the general formula (1) below is contained in the non-aqueous electrolyte, a reaction between the negative electrode active material and the non-aqueous electrolyte is restricted during charging and discharging under normal environments, so that charge-discharge cycle performances are improved.

The number of activated hydrogen in the fluorinated cyclic carbonate which has fluorine group and alkyl group and is represented by the general formula (1) is decreased as compared with a fluorinated cyclic carbonate which does not have alkyl group. This is thought to be a reason that a reaction between the negative electrode and the fluorinated cyclic carbonate is restricted even under high temperature and that deterioration of charge-discharge cycle performances is prevented.

Further, as in the present invention, as to the negative electrode during charging, when Li storage volume per unit area is determined as A, the theoretical maximum Li storage volume per unit area is determined as B, and a utilizing rate (%) of negative electrode as expressed by (A/B)×100 is 45% or less, expansion and contraction of the negative electrode active material because of charging and discharging are restricted and a stable charging and discharging can be repeated. The reason is thought to be as follows. If depth of charging and discharging is deeper, expansion and contraction of silicon become large and a lot of activated surfaces newly appear, and as a result, a reaction between activated surfaces and the non-aqueous electrolyte becomes excessive. Therefore, stable charging and discharging becomes impossible. In a non-aqueous electrolyte secondary battery of the present invention having the above-defined utilizing rate of negative electrode, activation of the negative electrode active material becomes not too high, a reaction between the negative electrode and the non-aqueous electrolyte is appropriately restricted, and charge-discharge cycle performances are further improved.

Consequently, in the non-aqueous electrolyte secondary battery of the present invention, even when the negative electrode comprising the negative electrode active material containing powdered silicon and/or silicon alloy and the binding agent is used, excellent charge-discharge cycle performances can be obtained under high temperature, not only under normal environments.

Examples of the fluorinated cyclic carbonate which has fluorine group and alkyl group and is represented by the general formula (1) include 4-fluoro-4-methyl-1,3-dioxolan-2-one, 4-fluoro-5-methyl-1,3-dioxolan-2-one, 4-fluoro-4,5-dimethyl-1,3-dioxolan-2-one, 4-fluoro-5,5-dimethyl-1,3-dioxolan-2-one, 4-fluoro-4,5,5-trimethyl-1-1,3-dioxolan-2-one, 4,5-difluoro-4,5-dimethyl-1,3-dioxolan-2-one, 4,4-difluoro-5,5-dimethyl-1,3-dioxolan-2-one, 4,4-difluoro-5-methyl-1,3-dioxolan-2-one and 4,5-difluoro-4-methyl-1,3-dioxolan-2-one.

In order to improve charge-discharge cycle performances of the non-aqueous electrolyte secondary battery by restricting deterioration of the negative electrode active material caused by expansion during charging and discharging, it is preferable to use 4-fluoro-4-methyl-1,3-dioxolan-2-one having electrochemical stability.

Moreover, it is preferable that at least one of ethylene carbonate and propylene carbonate is contained in the non-aqueous electrolyte. When at least one of ethylene carbonate and propylene carbonate is contained in the non-aqueous electrolyte, interaction between the fluorinated cyclic carbonate having fluorine group and alkyl group and ethylene carbonate or propylene carbonate contributes to form a favorable film on the negative electrode. As a result, charge-discharge reaction is further improved and charge-discharge cycle performances under high temperature are further improved.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a partial schematic sectional view and a schematic perspective view illustrating a flat-shape electrode fabricated in Examples and Comparative Examples of the present invention.

FIG. 2 is a schematic plain view showing a non-aqueous electrolyte secondary battery fabricated in Examples and Comparative Examples of the present invention.

### DESCRIPTION OF THE PREFERRED EMBODIMENTS

A non-aqueous electrolyte secondary battery according to the invention will hereinbelow be described in detail by way of examples thereof. It is to be noted that the non-aqueous electrolyte secondary battery according to the invention is not limited to the following examples and may be practiced with suitable modifications made thereto so long as such modifications do not deviate from the scope of the invention.

### Example 1

In Example 1, a positive electrode was prepared as follows. Lithium-cobalt oxide represented by LiCoO₂ which has an average particle diameter of 13 μm and BET specific surface area of 0.35 m²/g and zirconium was adhered to its surface was used as a positive electrode active material. Next, this positive electrode active material, carbon material powder as a conductive agent, and polyvinylidene fluoride as a binding agent were mixed in a weight ratio of 95:2.5:2.5. Then, the resultant mixture was kneaded with N-methyl-2-pyrrolidone solution to give positive electrode composite slurry.

As a positive electrode current collector, an aluminum foil having 15 μm thickness, 402 mm length, and 50 mm width was used. The positive electrode composite slurry was applied on one side of the positive electrode current collector. Here, the length and width of the positive electrode composite slurry applied on the one side of the positive electrode current collector were 340 mm and 50 mm. Next, the positive electrode composite slurry was applied on the other side of the positive electrode current collector. Here, the length and width of the positive electrode composite slurry applied on the other side of the positive electrode current collector were 271 mm and 50 mm. Then, the resultant was dried and rolled. Here, the positive electrode had thickness of 143 μm, the positive electrode composite on the positive electrode current collector was 48 mg/cm², and the filling density of the positive electrode composite was 3.75 g/cc.

After that, a positive electrode current collector tub of aluminum flat plate having 70 μm thickness, 35 mm length and 4 mm width was installed on the area which the positive electrode composite was not applied on.

In the non-aqueous electrolyte secondary battery according to the present invention, any publicly known positive electrode active material that has conventionally been used may be used as a positive electrode active material of the positive electrode. Examples of the positive electrode active material include lithium-containing transition metal oxide, such as lithium-cobalt oxide for example LiCoO₂, lithium-nickel oxide for example LiNiO₂, lithium-manganese oxide for example LiMn₂O₄ and LiMnO₂, lithium-nickel-cobalt oxide for example LiNi₁₋ₓCoₓO₂(0<x<1), lithium-manganese-cobalt oxide for example LiMn₁₋ₓCoₓO₂(0<x<1), lithium-nickel-cobalt-manganese oxide for example LiNiₓCo_{y}Mn_{z}O₂(x+y+z=1), and lithium-nickel-cobalt-aluminum oxide for example LiNiₓCo_{y}Al_{z}O₂(x+y+z=1).

Here, when lithium-cobalt oxide LiCoO₂ is used as the positive electrode active material, it is preferable that zirconium is adhered to the surface thereof so that a side reaction except for charge-discharge reaction on the interface between the non-aqueous electrolyte is restricted and that charge-discharge cycle performances are improved by its stable crystal structure.

A negative electrode was prepared as follows. A silicon powder having an average particle diameter of 10 μm and a purity of 99.9% was used as a negative electrode active material. The silicon powder as the negative electrode active material, graphite powder as a conductive agent and thermoplastic polyimide as a binding agent were weighed out in a weight ratio of 87:3:7.5 and were blended with N-methyl-2-pyrrolidone to give negative electrode composite slurry. Here, a glass transition temperature of thermoplastic polyimide was 295° C.

As a negative electrode current collector, Cu—Ni—Si—Mg (Ni: 3 wt %, Si: 0.65 wt %, Mg: 0.15 wt %) alloy foil having a surface roughness Ra of 0.3 μm and a thickness of 20 μm was used. Then, the prepared negative electrode composite slurry was applied on both sides of the negative electrode current collector and then was dried. Here, the amount of the negative electrode composite on the negative electrode current collector was 5.6 mg/cm².

The resultant negative electrode current collector was cut into a rectangle of 380 mm length and 52 mm width and then rolled. After that, the resultant material was sintered by heat-treatment at 400° C. for 10 hours under argon atmosphere. Thus, a negative electrode having a thickness of 56 μm after sintering was prepared.

Next, a negative electrode current collector tub made of nickel flat plate of 70 μm thickness, 35 mm length and 4 mm width was installed on the edge area of the negative electrode.

Examples of the foregoing silicon alloy used for the negative electrode active material include solid solution of silicon and at least one type of other elements, intermetallic compound of silicon and at least one type of other elements, and eutectic alloy of silicon and at least one type of other elements.

As a binding agent, it is preferable to use polyimide having a high strength. By using such polyimide, deterioration of the negative electrode active material containing powdered silicon and/or silicon alloy caused by expansion due to charging and discharging is restricted.

Further, it is preferable that the negative electrode current collector having a surface roughness Ra of 0.2 μm or more is used. In the case of using such a negative electrode current collector having such a surface roughness Ra of 0.2 μm, a contact area of the negative electrode active material and the negative electrode current collector is enlarged and the binding agent is entered into unevenness parts of the surface of the negative electrode current collector. Moreover, if sintering is conducted in such a condition, adhesive property between the negative electrode active material and the negative electrode current collector is enhanced by an anchoring effect. As a result, peeling of the negative electrode active material from the negative electrode current collector due to expansion and contraction of the negative electrode active material during charging and discharging is further restricted.

Further, the negative electrode composite containing the negative electrode active material of powdered silicon and/or silicon alloy and the binding agent was adhered to the surface of the negative electrode current collector and rolled before sintering at temperature which is not lower than glass transition temperature of the binding agent. By this, adhesive property among the negative electrode active material itself and that between the negative electrode active material and the negative electrode current collector are enhanced. As a result, peeling of the negative electrode active material from the negative electrode current collector due to expansion and contraction of the negative electrode active material during charging and discharging is restricted.

A non-aqueous electrolyte was prepared as follows. A non-aqueous solvent mixture was prepared by mixing ethylene carbonate (EC) with 4-fluoro-4-methyl-1,3-dioxolan-2-one (4-FPC) of fluorinated cyclic carbonate which has fluorine group and alkyl group and is represented by the general formula (1), and diethyl carbonate (DEC), in a volume ratio of 10:10:80. A solute of LiPF₆ was dissolved in the resultant solvent mixture in a concentration of 1.0 mol/l. Further, 0.4 mass % of carbon dioxide was dissolved therein.

In the non-aqueous electrolyte, any lithium salt that has conventionally been used may be employed as the solute to be dissolved in the non-aqueous solvent. Examples include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, which may be used either alone or in combination. In addition to these lithium salts, a lithium salt which has oxalate complex as an anion may preferably be contained. Examples of usable lithium salt which has oxalate complex as the anion include lithium-bis(oxalato)borate.

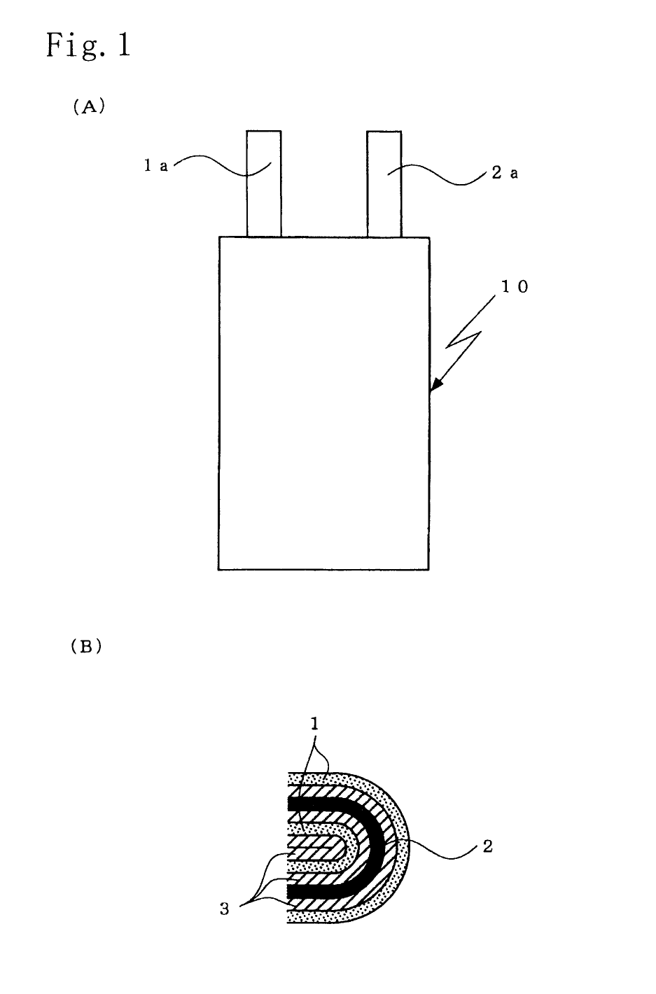

A non-aqueous electrolyte secondary battery was fabricated in the following manner. Two sheets of porous made of polyethylene having 22 μm thickness, 430 mm length and 54.5 mm width were used as separator. As illustrated in FIGS. 1(A) and 1(B), a positive electrode 1 and a negative electrode 2 were disposed to face each other by interposing a separator 3. These components were bent at prescribed position and spirally coiled and pressed to fabricate a flat electrode 10. A positive electrode current collector tub la installed on the positive electrode 1 and a negative electrode current collector tub 2a installed on the negative electrode 2 were protruded from the flat electrode 10.

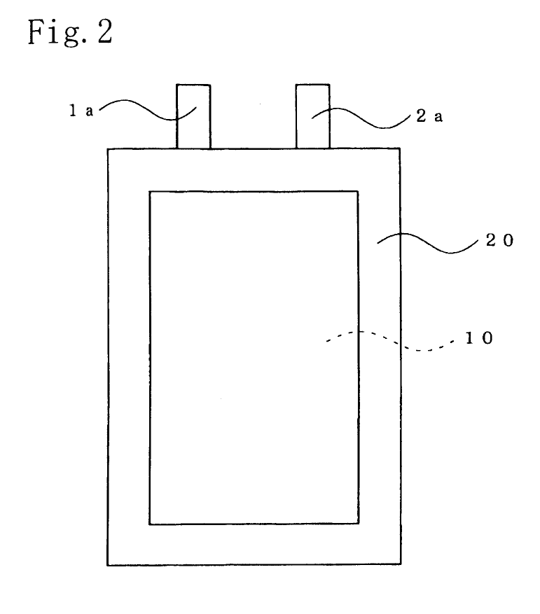

Next, as illustrated in FIG. 2, the flat electrode 10 was accommodated in a battery case 20 composed of aluminum laminate film, and the non-aqueous electrolyte prepared was poured into the battery case 20. Then, the open area of the battery case 20 was sealed so that the positive electrode current collector tub la and the negative electrode current collector tub 2a were thrust out. Thus, a non-aqueous electrolyte secondary battery having a design capacity of 950 mAh was obtained.

### Example 2

In Example 2, propylene carbonate (PC) was used instead of ethylene carbonate (EC) in preparation of the non-aqueous electrolyte of Example 1. A non-aqueous solvent mixture was prepared by mixing propylene carbonate (PC) with 4-fluoro-4-methyl-1,3-dioxolan-2-one (4-FPC), and diethyl carbonate (DEC), in a volume ratio of 10:10:80. Except for the above, the same procedure as in Example 1 was used to fabricate a non-aqueous electrolyte secondary battery of Example 2 having a design capacity of 950 mAh.

### Example 3

In Example 3, a non-aqueous solvent mixture was prepared by mixing 4-fluoro-4-metyl-1,3-dioxolan-2-one (4-FPC) with methyl ethyl carbonate (MEC) in a volume ratio of 20:80 in preparation of the non-aqueous electrolyte of Example 1. Except for the above, the same procedure as in Example 1 was used to fabricate a non-aqueous electrolyte secondary battery of Example 3 having a design capacity of 950 mAh.

### Example 4

In Example 4, a non-aqueous solvent mixture was prepared by mixing 4-fluoro-1,3-dioxolan-2-one (FEC) of fluorinated cyclic carbonate which does not have alkyl group, 4-fluoro-4-methyl-1,3-dioxolan-2-one (4-FPC) and methylethyl carbonate (MEC), in a volume ratio of 10:10:80 in preparation of the non-aqueous electrolyte of Example 1. Except for the above, the same procedure as in Example 1 was used to fabricate a non-aqueous electrolyte secondary battery of Example 4 having a design capacity of 950 mAh.

### Comparative Example 1

In Comparative Example 1, a non-aqueous solvent mixture was prepared by mixing ethylene carbonate (EC) with 4-fluoro-1,3-dioxolan-2-one (FEC) and diethyl carbonate (DEC), in a volume ratio of 10:10:80 in preparation of the non-aqueous electrolyte of Example 1. Except for the above, the same procedure as in Example 1 was used to fabricate a non-aqueous electrolyte secondary battery of Comparative Example 1 having a design capacity of 950 mAh.

### Comparative Example 2

In Comparative Example 2, a non-aqueous solvent mixture was prepared by mixing ethylene carbonate (EC), propylene carbonate (PC) and diethyl carbonate (DEC), in a volume ratio of 10:10:80 in preparation of the non-aqueous electrolyte of Example 1. Except for the above, the same procedure as in Example 1 was used to fabricate a non-aqueous electrolyte secondary battery of Comparative Example 2 having a design capacity of 950 mAh.

### Comparative Example 3

In Comparative Example 3, a non-aqueous solvent mixture was prepared by mixing ethylene carbonate (EC) and diethyl carbonate (DEC) in a volume ratio of 20:80 in preparation of the non-aqueous electrolyte of Example 1. Except for the above, the same procedure as in Example 1 was used to fabricate a non-aqueous electrolyte secondary battery of Comparative Example 3 having a design capacity of 950 mAh.

### Comparative Example 4

In Comparative Example 4, a non-aqueous solvent mixture was prepared by mixing 4-fluoro-1,3-dioxolan-2-one (FEC) and methyl ethyl carbonate (MEC) in a volume ratio of 20:80 in preparation of the non-aqueous electrolyte of Example 1. Except for the above, the same procedure as in Example 1 was used to fabricate a non-aqueous electrolyte secondary battery of Comparative Example 4 having a design capacity of 950 mAh.

In each of the non-aqueous electrolyte secondary batteries of Examples 1 to 4 and Comparative Examples 1 to 4, as to the negative electrode active material during charging, when Li storage volume per unit area is determined as A and the theoretical maximum Li storage volume per unit area is determined as B, a utilizing rate (%) of negative electrode as expressed by (A/B)×100 was 40%.

Next, each of the non-aqueous electrolyte secondary batteries of Examples 1 to 4 and Comparative Examples 1 to 4 having the design capacity of 950 mAh was subjected to initial charging and discharging under room temperature of 25° C. Each of the non-aqueous electrolyte secondary batteries was charged at a constant current of 190 mA until the voltage became 4.2 V. Further, each of the non-aqueous electrolyte batteries was charged at the constant voltage of 4.2 V until the current became 47 mA and then discharged at a constant current of 190 mA until the voltage became 2.75 V. Thus, an initial charging and discharging was performed.

Then, each of the non-aqueous electrolyte secondary batteries of Examples 1 to 4 and Comparative Examples 1 to 4 after initial charging and discharging was charged and discharged at room temperature of 25° C. in cycles. In one cycle, each of the non-aqueous electrolyte secondary batteries was charged at a constant current of 950 mA until the voltage became 4.2 V, further charged at a constant voltage of 4.2 V until the current became 47 mA, and discharged at the constant current of 950 mA until the voltage became 2.75 V. Such charging and discharging was repeated to two hundredth cycles.

Each of the non-aqueous electrolyte secondary batteries of Examples 1 to 4 and Comparative Examples 1 to 4 was determined for a discharge capacity Q1 at the first cycle and a discharge capacity Q200 at the two hundredth cycle. Then, the determined values were applied to the following equation to find a percentage of capacity preservation at two hundredth cycle under room temperature of 25° C.

Percentage of capacity preservation (%)=(Q200/Q1)×100

Next, each of the non-aqueous electrolyte secondary batteries of Examples 1 to 4 and Comparative Examples 1 to 4 after the initial charging and discharging was charged and discharged at high temperature of 45° C. in cycles. In one cycle, each of the non-aqueous electrolyte secondary batteries of Examples 1 to 4 and Comparative Examples 1 to 4 was charged at a constant current of 950 mA until the voltage became 4.2 V. Further, each of the non-aqueous electrolyte batteries was charged at the constant voltage of 4.2 V until the current became 47 mA and then discharged at a constant current of 950 mA until the voltage became 2.75 V. Such charging and discharging was repeated to two hundredth cycles.

Each of the non-aqueous electrolyte secondary batteries of Examples 1 to 4 and Comparative Examples 1 to 4 was determined for a discharge capacity Q1 at the first cycle and a discharge capacity Q200 at the two hundredth cycle. Then, a percentage of capacity preservation at two hundredth cycle under high temperature of 45° C. was determined.

Then, each of the non-aqueous electrolyte secondary batteries of Examples 1 to 4 and Comparative Examples 1 to 4 was determined for cycle life under room temperature of 25° C. and under high temperature of 45° C. by an index defining the percentage of capacity preservation of Example 1 at two hundredth cycles under room temperature of 25° C. as cycle life 100. The results are shown in Table 1 below.

TABLE 1

| | | | | | | | | Utilizing | | |
|---|---|---|---|---|---|---|---|---|---|---|
| | Adhesion Method of | Type and Volume Ratio of | | | | | | Rate(%) of | Cycle Life | |
| | Negative electrode | non-aqueous solvent | | | | | | Negative | Room | |
| | active material | EC | FEC | 4-FPC | PC | DEC | MEC | electrode | Temperature | 45° C. |
| Ex. 1 | application | 10 | — | 10 | — | 80 | — | 40 | 100 | 99 |
| Ex. 2 | application | — | — | 10 | 10 | 80 | — | 40 | 100 | 99 |
| Ex. 3 | application | — | — | 20 | — | — | 80 | 40 | 100 | 79 |
| Ex. 4 | application | — | 10 | 10 | — | — | 80 | 40 | 100 | 71 |
| Comp. | application | 10 | 10 | — | — | 80 | — | 40 | 101 | 48 |
| Ex. 1 | | | | | | | | | | |
| Comp. | application | 10 | — | — | 10 | 80 | — | 40 | 63 | 60 |
| Ex. 2 | | | | | | | | | | |
| Comp. | application | 20 | — | — | — | 80 | — | 40 | 68 | 65 |
| Ex. 3 | | | | | | | | | | |
| Comp. | application | — | 20 | — | — | — | 80 | 40 | 101 | 61 |
| Ex. 4 | | | | | | | | | | |

The results show that each of the non-aqueous electrolyte secondary batteries of Examples 1 to 4 and Comparative Examples 1 and 4 employing the non-aqueous electrolyte containing fluorinated cyclic carbonate is remarkably improved in cycle life under room temperature as compared with the non-aqueous electrolyte secondary batteries of Comparative Examples 2 and 3 employing the non-aqueous electrolyte wherein fluorinated cyclic carbonate was not contained.

Further, in each of the non-aqueous electrolyte secondary batteries of Examples 1 to 4 employing the non-aqueous electrolyte containing 4-fluoro-4-methyl-1,3-dioxolan-2-one (4-FPC) as fluorinated cyclic carbonate, decrease of cycle life under high temperature in comparison with cycle life under room temperature was suppressed as compared with the non-aqueous electrolyte secondary batteries of Comparative Examples 1 and 4.

Further, each of the non-aqueous electrolyte secondary batteries of Examples 1 and 2 employing the non-aqueous electrolyte containing 4-fluoro-4-methyl-1,3-dioxolan-2-one (4-FPC), ethylene carbonate and propylene carbonate shows further improved cycle life under high temperature as compared with the non-aqueous electrolyte secondary batteries of Examples 3 and 4 employing the non-aqueous electrolyte wherein ethylene carbonate and propylene carbonate were not contained.

### Comparative Example 5

In preparation of the positive electrode of Example 1, the amount of the positive electrode composite slurry applied on the positive electrode current collector was changed. Thus, a positive electrode of Comparative Example 5 had a thickness of 90 μm, the amount of the positive electrode composite on the positive electrode current collector was 28 mg/cm², and the filling density of positive electrode composite was 3.75 g/cc.

In preparation of a negative electrode, Cu—Ni—Si—Mg (Ni: 3 wt %, Si: 0.65 wt %, Mg: 0.15 wt %) alloy foil having a surface roughness Ra of 0.3 μm and a thickness of 6 μm was used as a negative electrode current collector. Then, the both sides of the negative electrode current collector were irradiated by Ar ion beam of which pressure was 0.05 Pa and ion current density was 0.27 mA/cm². After that, single crystal silicon was used as vapor deposition material to form a silicon thin film by electron beam deposition method on the both sides of the negative electrode current collector.

Here, results of measurement of a film thickness by SEM observation to a cross section of the negative electrode current collector on which surface the silicon thin film was formed showed that a silicon thin film having about 10 μm thickness was formed on the both sides of the negative electrode current collector. Then, the thin silicon film was subjected to a Raman spectrometer. As a result, a peak in the vicinity of 480 cm⁻¹ of wavelength was detected, but a peak in the vicinity of 520 cm⁻¹ of wavelength was not detected. Thus, it was found that the silicon thin film was an amorphous silicon thin film.

The negative electrode current collector on which surface the silicon thin film was formed was cut into a rectangle of 380 mm length and 52 mm width. Next, as the same as Example 1, a negative electrode current collector tub was installed. Thus, a negative electrode was prepared.

In preparation of non-aqueous electrolyte, the same as Comparative Example 1, a non-aqueous solvent mixture was prepared by mixing ethylene carbonate (EC) with 4-fluoro-1,3-dioxolan-2-one (FEC) and diethyl carbonate (DEC), in a volume ratio of 10:10:80.

Thus, except for the use of the positive electrode, the negative electrode and the non-aqueous electrolyte as prepared above, the same procedure as in Example 1 was used to fabricate a non-aqueous electrolyte secondary battery of Comparative Example 5 having a design capacity of 600 mAh.

### Comparative Example 6

In comparative Example 6, the same as the non-aqueous electrolyte of Example 1, a non-aqueous solvent mixture was prepared by mixing ethylene carbonate (EC) with 4-fluoro-4-methyl-1,3-dioxolan-2-one (4-FPC) of fluorinated cyclic carbonate which has fluorine group and alkyl group and is represented by the general formula (1), and diethyl carbonate (DEC), in a volume ratio of 10:10:80. Except for the above, the same procedure as in Comparative Example 5 was used to fabricate a non-aqueous electrolyte secondary battery of Comparative Example 6 having a design capacity of 600 mAh.

As to the non-aqueous electrolyte secondary batteries of Comparative Examples 5 and 6, a utilizing rate (%) of the both negative electrode was 40%.

Next, each of the non-aqueous electrolyte secondary batteries of Comparative Examples 5 and 6 having the design capacity of 600 mAh was subjected to initial charging and discharging under room temperature of 25° C. Each of the non-aqueous electrolyte secondary batteries was charged at a constant current of 120 mA until the voltage became 4.2 V. Further, each of the non-aqueous electrolyte batteries was charged at the constant voltage of 4.2 V until the current became 30 mA and then discharged at a constant current of 120 mA until the voltage became 2.75 V. Thus, an initial charging and discharging was performed.

Then, each of the non-aqueous electrolyte secondary batteries of Comparative Examples 5 and 6 after initial charging and discharging was charged and discharged at room temperature of 25° C. in cycles. In one cycle, each of the non-aqueous electrolyte secondary batteries was charged at a constant current of 600 mA until the voltage became 4.2 V, further charged at a constant voltage of 4.2 V until the current became 30 mA, and discharged at the constant current of 600 mA until the voltage became 2.75 V. Such charging and discharging was repeated to two hundredth cycles.

Each of the non-aqueous electrolyte secondary batteries of Comparative Examples 5 and 6 was determined for a discharge capacity Q1 at the first cycle and a discharge capacity Q200 at the two hundredth cycle. Then, a percentage of capacity preservation at two hundredth cycle under room temperature of 25° C. was determined.

Next, each of the non-aqueous electrolyte secondary batteries of Comparative Examples 5 and 6 after the initial charging and discharging was charged and discharged at high temperature of 45° C. in cycles. In one cycle, each of the non-aqueous electrolyte secondary batteries of Comparative Examples 5 and 6 was charged at a constant current of 600 mA until the voltage became 4.2 V. Further, each of the non-aqueous electrolyte batteries was charged at the constant voltage of 4.2 V until the current became 30 mA and then discharged at a constant current of 600 mA until the voltage became 2.75 V. Such charging and discharging was repeated to two hundredth cycles.

Each of the non-aqueous electrolyte secondary batteries of Comparative Examples 5 and 6 was determined for a discharge capacity Q1 at the first cycle and a discharge capacity Q200 at the two hundredth cycle. Then, a percentage of capacity preservation at two hundredth cycle under high temperature of 45° C. was determined.

Then, each of the non-aqueous electrolyte secondary batteries of Comparative Examples 5 and 6 was determined for cycle life under room temperature of 25° C. and under high temperature of 45° C. by an index defining the percentage of capacity preservation of Comparative Example 5 at two hundredth cycles under room temperature of 25° C. as cycle life 100. The results are shown in Table 2 below.

TABLE 2

| | | | | | | | | Utilizing | | |
|---|---|---|---|---|---|---|---|---|---|---|
| | Adhesion Method of | Type and Volume Ratio of | | | | | | Rate(%) of | Cycle Life | |
| | Negative electrode | non-aqueous solvent | | | | | | Negative | Room | |
| | active material | EC | FEC | 4-FPC | PC | DEC | MEC | electrode | Temperature | 45° C. |
| Comp. | Vapor | 10 | 10 | — | — | 80 | — | 40 | 100 | 99 |
| Ex. 5 | deposition | | | | | | | | | |
| Comp. | Vapor | 10 | — | 10 | — | 80 | — | 40 | 98 | 99 |
| Ex. 6 | deposition | | | | | | | | | |

The results show that, as to the non-aqueous electrolyte secondary batteries of Comparative Examples 5 and 6 employing the negative electrode wherein the silicon thin film was formed on the negative electrode current collector by electron beam deposition method, decrease of the cycle life under high temperature in comparison with the cycle life under room temperature was suppressed, even if the non-aqueous electrolyte secondary battery of Comparative Example 5 used fluorinated cyclic carbonate which does not have alkyl group and the non-aqueous electrolyte secondary battery of Comparative Example 6 used fluorinated cyclic carbonate which has fluorine group and alkyl group.

Accordingly, the result that decrease of the cycle life under high temperature is suppressed by containing of fluorinated cyclic carbonate which has fluorine group and alkyl group and is represented by the general formula (1) in the non-aqueous electrolyte is found to be a peculiar effect obtained in the non-aqueous electrolyte secondary battery employing the negative electrode in which the silicon powder of negative electrode active material and the binding agent were applied on the negative electrode current collector.

### Comparative Example 7

In preparation of the positive electrode of Example 1, the amount of the positive electrode composite slurry applied on the positive electrode current collector was changed. Thus, a positive electrode of Comparative Example 7 had a thickness of 148 μm, the amount of the positive electrode composite on the positive electrode current collector was 50 mg/cm², and the filling density of positive electrode composite was 3.75 g/cc.

In preparation of a negative electrode, alloy powder comprised of tin, cobalt, titanium and indium was used as a negative electrode active material. The alloy powder was prepared as follows. Tin, cobalt, titanium and indium were mixed in the atom ratio of 45:45:9:1, and the mixture was melted, rapid-cooled and then was pulverized.

Next, 78 parts by mass of the alloy powder was mixed with 22 parts by mass of acetylene black of carbon material, then, mechanical alloying treatment was applied by using a planetary ball mill in argon atmosphere for 15 hours to prepare a negative electrode active material comprised of a complex alloy powder.

The prepared negative electrode active material was mixed with a conductive agent of scale-shaped artificial graphite having an average particle diameter of 20 μm in a mass ratio of 6:4. Then, the mixture of the positive electrode active material and the conductive agent was mixed with polyvinylidene fluoride as a binding agent in a mass ratio of 98.4:1.6. Next, the resultant mixture was kneaded with N-methyl-2-pyrrolidone solution to prepare negative electrode composite slurry.

Then, the prepared negative electrode composite slurry was applied on the both sides of the negative electrode current collector of electrolytic copper foil having a thickness of 10 μm and then was dried at 120° C. Here, the amount of the negative electrode composite on the negative electrode current collector was 19.5 mg/cm².

The resultant material was pressed by roller press and was cut into a rectangle of 380 mm length and 52 mm width to prepare a negative electrode. The negative electrode thus prepared had a thickness of 75 μm.

After that, a negative electrode current collector tub of nickel flat plate having 70 μm thickness, 35 mm length and 4 mm width was installed on the edge area of the negative electrode.

In preparation of non-aqueous electrolyte, the same as Example 1, a non-aqueous solvent mixture was prepared by mixing ethylene carbonate (EC), 4-fluoro-4-methyl-1,3-dioxolan-2-one (4-FPC) and diethyl carbonate (DEC), in a volume ratio of 10:10:80.

Except that the positive electrode and the negative electrode as prepared above were employed, the same procedure as in Example 1 was used to fabricate a non-aqueous electrolyte secondary battery of Comparative Example 7 having a design capacity of 800 mAh.

### Comparative Example 8

In Comparative Example 8, the same as the non-aqueous electrolyte of Comparative Example 1, a non-aqueous solvent mixture was prepared by mixing ethylene carbonate (EC), 4-fluoro-1,3-dioxolan-2-one (FEC) and diethyl carbonate (DEC), in a volume ratio of 10:10:80. Except for the above, the same procedure as in Comparative Example 7 was used to fabricate a non-aqueous electrolyte secondary battery of Comparative Example 8 having a design capacity of 800 mAh.

As to the non-aqueous electrolyte secondary batteries of Comparative Examples 7 and 8, a utilizing rate (%) of the both negative electrodes was 91%. When tin alloy is used as a material of the negative electrode active material as in the non-aqueous electrolyte secondary batteries of Comparative Examples 7 and 8, charge-discharge cycle can be repeated even if a utilizing rate of negative electrode is high.

Next, each of the non-aqueous electrolyte secondary batteries of Comparative Examples 7 and 8 having the design capacity of 800 mAh was subjected to initial charging and discharging under room temperature of 25° C. Each of the non-aqueous electrolyte secondary batteries was charged at a constant current of 160 mA until the voltage became 4.2 V. Further, each of the non-aqueous electrolyte batteries was charged at the constant voltage of 4.2 V until the current became 40 mA and then discharged at a constant current of 160 mA until the voltage became 2.5 V. Thus, an initial charging and discharging was performed.

Then, each of the non-aqueous electrolyte secondary batteries of Comparative Examples 7 and 8 after initial charging and discharging was charged and discharged at room temperature of 25° C. in cycles. In one cycle, each of the non-aqueous electrolyte secondary batteries was charged at a constant current of 800 mA until the voltage became 4.2 V, further charged at a constant voltage of 4.2 V until the current became 40 mA, and discharged at the constant current of 800 mA until the voltage became 2.75 V. Such charging and discharging was repeated to two hundredth cycles.

Then, each of the non-aqueous electrolyte secondary batteries of Comparative Examples 7 and 8 was determined for a discharge capacity Q1 at the first cycle and a discharge capacity Q200 at the two hundredth cycle. Then, a percentage of capacity preservation at two hundredth cycle under room temperature of 25° C. was determined.

Next, each of the non-aqueous electrolyte secondary batteries of Comparative Examples 7 and 8 after the initial charging and discharging was charged and discharged at high temperature of 45° C. in cycles. In one cycle, each of the non-aqueous electrolyte secondary batteries of Comparative Examples 7 and 8 was charged at a constant current of 800 mA until the voltage became 4.2 V. Further, each of the non-aqueous electrolyte batteries was charged at the constant voltage of 4.2 V until the current became 40 mA and then discharged at a constant current of 800 mA until the voltage became 2.75 V. Such charging and discharging was repeated to two hundredth cycles.

Then, each of the non-aqueous electrolyte secondary batteries of Comparative Examples 7 and 8 was determined for a discharge capacity Q1 at the first cycle and a discharge capacity Q200 at the two hundredth cycle. Then, a percentage of capacity preservation at two hundredth cycle under high temperature of 45° C. was determined.

Next, each of the non-aqueous electrolyte secondary batteries of Comparative Examples 7 and 8 was determined for cycle life under room temperature of 25° C. and under high temperature of 45° C. by an index defining the percentage of capacity preservation of Comparative Example 7 at two hundredth cycles under room temperature of 25° C. as cycle life 100. The results are shown in Table 3 below.

TABLE 3

| | | | | | | | | Utilizing | | |
|---|---|---|---|---|---|---|---|---|---|---|
| | Adhesion Method of | Type and Volume Ratio of | | | | | | Rate(%) of | Cycle Life | |
| | Negative electrode | non-aqueous solvent | | | | | | Negative | Room | |
| | active material | EC | FEC | 4-FPC | PC | DEC | MEC | electrode | Temperature | 45° C. |
| Comp. | Application | 10 | — | 10 | — | 80 | — | 91 | 100 | 98 |
| Ex. 7 | | | | | | | | | | |
| Comp. | Application | 10 | 10 | — | — | 80 | — | 91 | 99 | 99 |
| Ex. 8 | | | | | | | | | | |

The results show that decrease of the cycle life under high temperature in comparison with the cycle life under room temperature was suppressed in the non-aqueous electrolyte secondary batteries of Comparative Examples 7 and 8 using alloy powder comprising tin and so on instead of silicon powder, even if the non-aqueous electrolyte secondary battery of Comparative Examples 7 used fluorinated cyclic carbonate which has fluorine group and alkyl group and the non-aqueous electrolyte secondary battery of Comparative Examples 8 used fluorinated cyclic carbonate which does not have alkyl group.

Accordingly, the result that decrease of the cycle life under high temperature is suppressed by containing of fluorinated cyclic carbonate which has fluorine group and alkyl group and is represented by the general formula (1) in the non-aqueous electrolyte is found to be a peculiar effect obtained in the non-aqueous electrolyte secondary battery employing the negative electrode in which the silicon powder of negative electrode active material and the binding agent were applied on the negative electrode current collector.

### Example 5

In preparation of the positive electrode of Example 1, the amount of the positive electrode composite slurry applied on the positive electrode current collector was changed. Thus, a positive electrode of Example 5 had a thickness of 151 μm, the amount of the positive electrode composite on the positive electrode current collector was 51 mg/cm², and the filling density of positive electrode composite was 3.75 g/cc.

In preparation of the negative electrode of Example 1, the amount of the negative electrode composite slurry applied on the negative electrode current collector was changed. Thus, a negative electrode of Example 5 in which the amount of the negative electrode composite applied on the negative electrode current collector was 4.9 mg/cm² was prepared. The negative electrode of Example 5 after sintering had a thickness of 40 μm.

Then, the positive electrode and the negative electrode prepared as above and the non-aqueous electrolyte of Example 1 were used to fabricate a non-aqueous electrolyte secondary battery of Example 5. The non-aqueous electrolyte secondary battery of Example 5 had a design capacity of 1060 mAh and the utilizing rate (%) of negative electrode was 45%.

Next, the non-aqueous electrolyte secondary battery of Example 5 having the design capacity of 1060 mAh was subjected to initial charging and discharging under room temperature of 25° C. The non-aqueous electrolyte secondary battery was charged at a constant current of 212 mA under room temperature of 25° C. until the voltage became 4.2 V. Further, the non-aqueous electrolyte secondary battery was charged at the constant voltage of 4.2 V until the current became 53 mA and then discharged at a constant current of 212 mA until the voltage became 2.75 V. Thus, an initial charging and discharging was performed.

Then, the non-aqueous electrolyte secondary battery of

Example 5 after initial charging and discharging was charged and discharged at room temperature of 25° C. in cycles. In one cycle, the non-aqueous electrolyte secondary battery was charged at a constant current of 1060 mA until the voltage became 4.2 V, further charged at a constant voltage of 4.2 V until the current became 53 mA, and discharged at the constant current of 1060 mA until the voltage became 2.75 V. Such charging and discharging was repeated to one hundred fiftieth cycles. Then, a percentage of capacity preservation at one hundred fiftieth cycle under room temperature of 25° C. was determined.

Then, the non-aqueous electrolyte secondary battery of Example 5 after initial charging and discharging was charged and discharged at high temperature of 45° C. in cycles. In one cycle, the non-aqueous electrolyte secondary battery was charged at a constant current of 1060 mA until the voltage became 4.2 V, further charged at a constant voltage of 4.2 V until the current became 53 mA, and discharged at the constant current of 1060 mA until the voltage became 2.75 V. Such charging and discharging was repeated to one hundred fiftieth cycles. Then, a percentage of capacity preservation at one hundred fiftieth cycle under high temperature of 45° C. was determined.

### Comparative Example 9

In preparation of the positive electrode of Example 1, the amount of the positive electrode composite slurry applied on the positive electrode current collector was changed. Thus, a positive electrode of Comparable Example 9 had a thickness of 159 μm, the amount of the positive electrode composite on the positive electrode current collector was 54 mg/cm², and the filling density of the positive electrode composite was 3.75 g/cc.

In preparation of the negative electrode of Example 1, the amount of the negative electrode composite slurry applied on the negative electrode current collector was changed. Thus, a negative electrode of Comparative Example 9 in which the amount of the negative electrode composite applied on the negative electrode current collector was 3.6 mg/cm² was prepared. The negative electrode of Comparative Example 9 after sintering had a thickness of 40 μm.

Then, the positive electrode and the negative electrode prepared as above and the non-aqueous electrolyte of Example 1 were used to fabricate a non-aqueous electrolyte secondary battery of Comparative Example 9. The non-aqueous electrolyte secondary battery of Comparative Example 9 had a design capacity of 1140 mAh and the utilizing rate (%) of negative electrode was 63%.

Next, the non-aqueous electrolyte secondary battery of Comparative Example 9 having the design capacity of 1140 mAh was subjected to initial charging and discharging under room temperature of 25° C. The non-aqueous electrolyte secondary battery was charged at a constant current of 228 mA until the voltage became 4.2 V. Further, the non-aqueous electrolyte secondary battery was charged at the constant voltage of 4.2 V until the current became 48 mA and then discharged at a constant current of 228 mA until the voltage became 2.75 V. Thus, an initial charging and discharging was performed.

Then, the non-aqueous electrolyte secondary battery of Comparative Example 9 after initial charging and discharging was charged and discharged at room temperature of 25° C. in cycles. In one cycle, the non-aqueous electrolyte secondary battery was charged at a constant current of 1140 mA until the voltage became 4.2 V, further charged at a constant voltage of 4.2 V until the current became 57 mA, and discharged at the constant current of 1140 mA until the voltage became 2.75 V. Such charging and discharging was repeated to one hundred fiftieth cycles. Then, a percentage of capacity preservation at one hundred fiftieth cycle under room temperature of 25° C. was determined.

Then, the non-aqueous electrolyte secondary battery of

Comparative Example 9 after initial charging and discharging was charged and discharged at high temperature of 45° C. in cycles. In one cycle, the non-aqueous electrolyte secondary battery was charged at a constant current of 1140 mA until the voltage became 4.2 V, further charged at a constant voltage of 4.2 V until the current became 57 mA, and discharged at the constant current of 1140 mA until the voltage became 2.75 V. Such charging and discharging was repeated to one hundred fiftieth cycles. Then, a percentage of capacity preservation at one hundred fiftieth cycle under high temperature of 45° C. was determined.

Next, each of the non-aqueous electrolyte secondary batteries of Example 5 and Comparative Examples 9 was determined for cycle life under room temperature of 25° C. and under high temperature of 45° C. by an index defining the percentage of capacity preservation of Example 1 at one hundred fiftieth cycle under room temperature of 25° C. as cycle life 100. The results are shown in Table 4 below.

TABLE 4

| | | | | | | | | Utilizing | | |
|---|---|---|---|---|---|---|---|---|---|---|
| | Adhesion Method of | Type and Volume Ratio of | | | | | | Rate(%) of | Cycle Life | |
| | Negative electrode | non-aqueous solvent | | | | | | Negative | Room | |
| | active material | EC | FEC | 4-FPC | PC | DEC | MEC | electrode | Temperature | 45° C. |
| Ex. 1 | Application | 10 | — | 10 | — | 80 | — | 40 | 100 | 99 |
| Ex. 5 | Application | 10 | — | 10 | — | 80 | — | 45 | 96 | 95 |
| Comp. | Application | 10 | — | 10 | — | 80 | — | 63 | 51 | 30 |
| Ex. 9 | | | | | | | | | | |

According to the results, both of the cycle life under room temperature of 25° C. and the cycle life under high temperature of 45° C. in the non-aqueous electrolyte secondary batteries of Comparative Example 9 having 63% of utilizing rate of negative electrode were greatly decreased as compared with the non-aqueous electrolyte secondary batteries of Examples 1 and 5 having 45% or less of utilizing rate of negative electrode.

The reason is thought to be as follows. If depth of charging and discharging is deep as in the non-aqueous electrolyte secondary batteries of Comparative Example 9, expansion and contraction of silicon become large and a lot of activated surfaces newly appear, and as a result, a reaction between activated surfaces and the non-aqueous electrolyte becomes excessive. Therefore, performing of stable charging and discharging is impossible in Comparative Example 9.

Although the present invention has been fully described by way of examples, it is to be noted that various changes and modifications will be apparent to those skilled in the art.

Therefore, unless otherwise such changes and modifications depart from the scope of the present invention, they should be construed as being included therein.

1. A non-aqueous electrolyte secondary battery comprises:
a positive electrode; a negative electrode; a separator interposed between the positive electrode and the negative electrode; and a non-aqueous electrolyte dissolving a solute in a non-aqueous solvent;
wherein the negative electrode comprises a negative electrode active material containing powdered silicon and/or silicon alloy and a binding agent, and the non-aqueous electrolyte contains a fluorinated cyclic carbonate represented by a general formula (1) below;
and wherein, when Li storage volume per unit area in the negative electrode during charging is determined as A and the theoretical maximum Li storage volume per unit area in the negative electrode is determined as B, a utilizing rate (%) of negative electrode as expressed by (A/B)×100 is 45% or less. 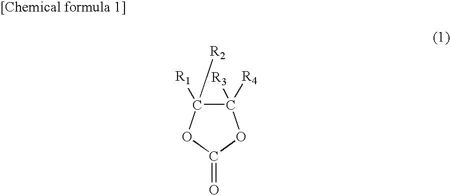
(In the chemical formula, R1 to R4 are groups selected from hydrogen group, fluorine group and alkyl group and contain at least one fluorine group and one alkyl group respectively.)

2. The non-aqueous electrolyte secondary battery as claimed in claim 1,
wherein said fluorinated cyclic carbonate is 4-fluoro-4-methyl-1,3-dioxolan-2-one.

3. The non-aqueous electrolyte secondary battery as claimed in claim 1,
wherein said non-aqueous electrolyte contains at least one of ethylene carbonate and propylene carbonate.

4. The non-aqueous electrolyte secondary battery as claimed in claim 2,
wherein said non-aqueous electrolyte contains at least one of ethylene carbonate and propylene carbonate.

5. The non-aqueous electrolyte secondary battery as claimed in claim 1,
wherein said binding agent is polyimide.

6. The non-aqueous electrolyte secondary battery as claimed in claim 1,
wherein a negative electrode composite containing the negative electrode active material of powdered silicon and/or silicon alloy and the binding agent is adhered to the surface of a negative electrode current collector of the negative electrode.

7. The non-aqueous electrolyte secondary battery as claimed in claim 6,
wherein the negative electrode after rolling is sintered at a temperature which is not lower than glass transition temperature under non-oxidation atmosphere.

8. The non-aqueous electrolyte secondary battery as claimed in claim 6,
wherein the negative electrode current collector has a surface roughness Ra of 0.2 μm or more.
